(19) United States
(12) Patent Application Publication
(10) Pub. No.: US 2026/0067237 A1
(43) Pub. Date: Mar. 5, 2026

(54) WIRELESS COMMUNICATION SYSTEM AND METHOD FOR CONTROLLING WIRELESS COMMUNICATION SYSTEM

(71) Applicant: Delta Electronics, Inc., Taoyuan City (TW)

(72) Inventors: Yu-Wei LEE, Taoyuan City (TW); Chih-Kuan YEN, Taoyuan City (TW); Chin-Ming CHEN, Taoyuan City (TW)

(21) Appl. No.: 19/044,800

(22) Filed: Feb. 4, 2025

(30) Foreign Application Priority Data
Sep. 2, 2024 (CN) 202411215529.5

(51) Int. Cl. H04L 49/55; H04B 7/10

(52) U.S. Cl. CPC H04L 49/555; H04B 7/10

(57) ABSTRACT

A wireless communication system is provided. The wireless communication system includes a control substrate and wireless communication devices. The wireless communication devices wirelessly communicatively connect to each other in sequence to form a first chain. The wireless communication devices at the two ends of the first chain are respectively wirelessly communicatively coupled to the control substrate. The control substrate transmits the control signal to one of the wireless communication devices that are directly coupled to the control substrate and receives the response signal from another one of the wireless communication devices that are directly coupled to the control substrate. The control substrate determines whether communication among the wireless communication devices is abnormal based on the transmission and reception status of the control signal and the response signal. The control substrate transmits two error detection packets to locate the wireless communication devices having errors, when the communication is abnormal.

### CROSS REFERENCE TO RELATED APPLICATIONS

This Application claims priority of China Patent Application No. 202411215529.5, filed on Sep. 2, 2024, the entirety of which is incorporated by reference herein.

### BACKGROUND OF THE INVENTION

### Field of the Invention

The present invention relates to wireless communication systems, and, in particular, to communication interruption detection and recovery mechanisms.

### Description of the Related Art

In a battery management system (BSM), all batteries have to be connected to a monitor circuit board using wiring so as to monitor every battery. The complex connection of the wires can negatively affect the cost, quality, and reliability of mass production. Thus, a battery management system that uses wireless communication has become a trend in this field. However, a mechanism for detecting an interruption in the wireless system is required. Furthermore, a mechanism for restoring communication after said interruption in the wireless system is also required.

### BRIEF SUMMARY OF THE INVENTION

Embodiments of the present disclosure provide a wireless communication system. The wireless communication system comprises a control substrate and a plurality of wireless communication devices. The control substrate has the first communication device, and the first communication device is equipped with a first antenna and a second antenna. The wireless communication devices include a first wireless communication group. Each of the wireless communication devices comprises a node substrate and a second communication device. The second communication device has a third antenna located on the first end of the node substrate and a fourth antenna located on the second end, which is relative to the first end, of the node substrate. The wireless communication devices in the first wireless communication group wirelessly communicatively connect to each other in sequence to form the first chain. The wireless communication devices at the two ends of the first chain are respectively wirelessly communicatively coupled to the first antenna and the second antenna of the first communication device of the control substrate. The first antenna of the first communication device of the control substrate transmits the control signal to the third antenna of the second communication device that is directly coupled to the first communication device, and the second antenna of the first communication device receives a response signal from the fourth antenna of the second communication device that is directly coupled to the first communication device. The control substrate is configured to check the transmission and reception status of the control signal and the response signal based on the predetermined amount of time to determine whether communication among the wireless communication devices is abnormal. The first communication device is configured to transmit a first error detection packet and a second error detection packet to locate the node substrate having an error among the wireless communication devices, when communication among the wireless communication devices is abnormal.

Embodiments of the present disclosure provide a method for controlling the wireless communication system. The method is applicable to a wireless communication system. The wireless communication system comprises a control substrate and a plurality of wireless communication devices. The control substrate comprises a first communication device, and the first communication device is equipped with a first antenna and a second antenna. The wireless communication devices include a first wireless communication group. Each of the wireless communication devices comprises a node substrate and a second communication device, a third antenna located on the first end of the node substrate, and a fourth antenna located on a second end, which is relative to the first end, of the node substrate. The wireless communication devices in the first wireless communication group wirelessly communicatively connect to each other in sequence to form a first chain. The wireless communication devices at the two ends of the first chain are respectively wirelessly communicatively coupled to the first antenna and the second antenna of the first communication device of the control substrate. The first antenna of the first communication device of the control substrate transmits a control signal to the third antenna of the second communication device that is directly coupled to the first communication device, and the second antenna of the first communication device receives a response signal from the fourth antenna of the second communication device that is directly coupled to the first communication device. The method comprises checking the transmission and the reception status of the control signal and the response signal based on a predetermined amount of time to determine whether communication among the wireless communication devices is abnormal using the control substrate. The method further comprises transmitting a first error detection packet and a second error detection packet to locate the node substrate having an error among the wireless communication devices using the first communication device, when communication among the wireless communication devices is abnormal.

### BRIEF DESCRIPTION OF THE DRAWINGS

The present invention can be more fully understood by reading the subsequent detailed description and examples with references made to the accompanying drawings, wherein:

FIG. 1 is the block diagram of the wireless communication system in accordance to the embodiments of the present disclosure;

FIG. 2 is the block diagram of the wireless communication system in accordance to the embodiments of the present disclosure;

FIG. 3 is the block diagram of the wireless communication system in accordance to the embodiments of the present disclosure;

FIG. 4 is the schematic diagram of the communication system in accordance to the embodiments of the present disclosure;

FIGS. 5A, 5B are the schematic diagram of the method for controlling the communication system in accordance to the embodiments of the present disclosure;

FIGS. 6A, 6B are the schematic diagram of the method for controlling the communication system in accordance to the embodiments of the present disclosure; and

FIG. 7 is the flow diagram of the method for controlling the communication system in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

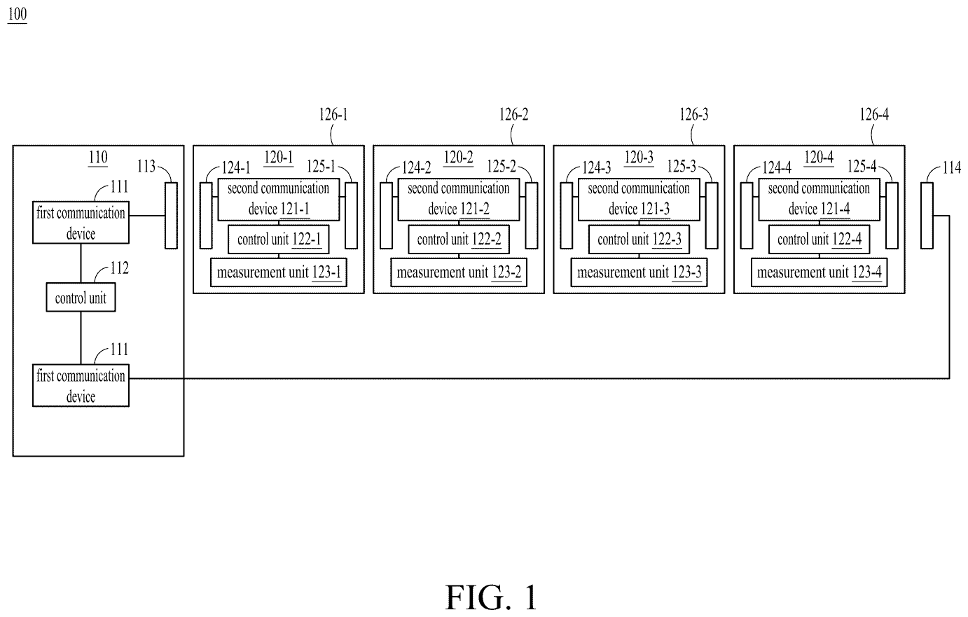

Refer to FIG. 1. FIG. 1 is a block diagram of the wireless communication system 100 in accordance to the embodiments of the present disclosure. The wireless communication 100 comprises a control substrate 110 and wireless communication device 120-1, 120-2, 120-3, 120-4. The control substrate 110 comprises a first communication device 111 and a control unit 112. The first communication 111 is equipped with a first antenna 113 and a second antenna 114. The wireless communication devices 120-1-120-4 respectively comprises second communication devices 121-1-121-4, control units 122-1-122-4 , and measurement units 123-1-123-4. The second communication devices 121-1-121-4 are equipped with third antennas 124-1-124-4 located on the first end of the node substrates 126-1-126-4, and fourth antennas 125-1-125-4 located on the second end, which is relative to the first end, of the node substrates 126-1-126-4. In some embodiments, the second communication devices 121-1-121-4, the control units 121-1-121-4, the measurement units 123-1-123-4, the third antennas 124-1-124-4, and the fourth antennas 125-1-125-4 are mounted on the node substrates 126-1-126-4. For example, the node substrates 126-1-126-4 may comprise the second communication devices 121-1-121-4, the control units 121-1-121-4, and the measurement units 123-1-123-4. In some embodiments, the node substrates 126-1-126-4 are printed circuit boards (PCB).

The control unit 112 is configured to control the control substrate 110. The control unit 122-1 is configured to control the wireless communication device 120-1. In some embodiments, the control unit 112 and 122-1 may include the micro-processor, the central processing unit (CPU), the general-purpose processor, the special-purpose processor, or the micro control unit (MCU).

The first communication device 111 connects to the first antenna 113 and the second antenna 114. The second communication device 121-1 connects to the third antenna 124-1 and the fourth antenna 125-1. The first communication device 111 is configured to wirelessly transmit or receive signals through the first antenna 113 and the second antenna 114. The second communication device 121-1 is configured to wirelessly transmit or receive signals through the third antenna 124-1 and/or the fourth antenna 125-1. In some embodiments, the first communication device 111 and the second communication device 121-1 comprises transceivers, radio frequency circuits, or filters. In some embodiments, the first antenna 113, the second antenna 114, the third antenna 124-1, and the fourth antenna 125-1 are PCB trace antennas.

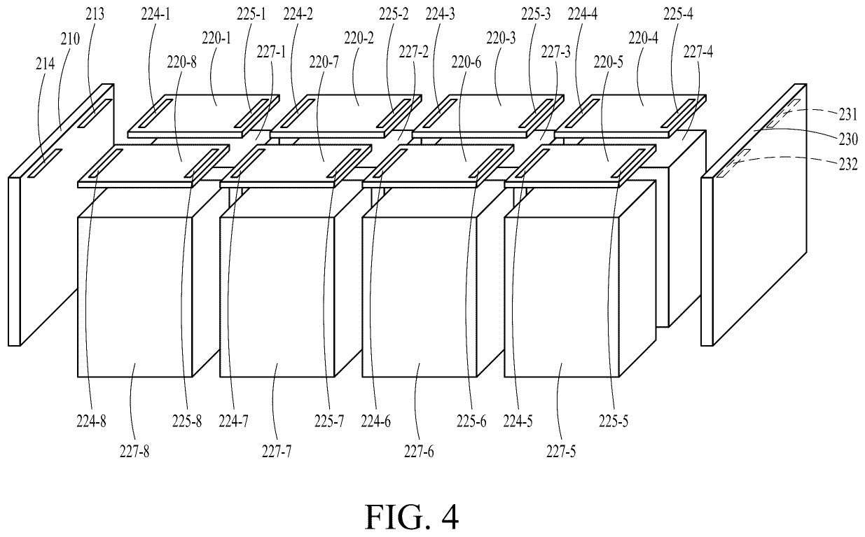

The measurement unit 123-1 is configured to measure the parameters of the battery of the wireless communication device 120-1 (refer to FIG. 4). In some embodiments, the measurement unit 123-1 is configured to measure the voltage, the current, the temperature, and the impedance of the battery. In some embodiments, the measurement unit 123-1 comprises multiple sensors, such as the voltage sensor, the current sensor, the temperature sensor, and the impedance sensor.

Furthermore, the control substrate 110 and the wireless communication device 120-1 may comprise other components which aren't shown in the FIG. 1. For example, the control substrate 110 and the wireless communication device 120-1 may comprise memory, speaker, display, timer, and user interface device.

The wireless communication device 120-2-120-4 are similar to the wireless device 120-1. Thus, the second communication devices 121-2-121-4 are similar to the second communication device 121-1, the control units 122-2-122-4 are similar to the control unit 122-1, and the measurements units 123-2-123-4 are similar to the measurements unit 123-1 In some embodiments, the wireless communication devices 120-1-120-4 have configured identifiers (ID) or numbers.

The wireless communication devices 120-1-120-4 form the first wireless communication group. The wireless communication devices 120-1-120-4 in the first wireless communication group wirelessly communicatively connect to each other in sequence to form the first chain. The wireless communication devices 120-1 and 120-4 at the two ends of the first chain are respectively wirelessly communicatively coupled to the first antenna 113 and the second antenna 114 of the first communication device 111 of the control substrate 110. The first antenna 113 of the first communication device 111 of the control substrate 110 transmits the control signal to the third antenna 124-1 of the second communication device 121-1 that is directly coupled to the first communication device 111. The second antenna 114 of the first communication device 111 receives the response signal from the fourth antenna 125-1 of the second communication device 120-4 that is directly coupled to the first communication device 111. Specifically, the control substrate 110 may wirelessly transmit the control signal (e.g. the packet, or the packet including the instruction, such as the measurement instruction) through the first antenna 113 to the wireless communication device 120-1. The wireless communication device 120-1 receives the control signal through the third antenna 124-1 and transmit the control signal to the wireless communication device 120-2 through the fourth antenna 125-1. The wireless communication devices 120-1-120-4 transmit the control signal in the aforementioned manner in sequence. The control signal passes through wireless communication devices 120-1, 120-2, 120-3, 120-4 in sequence, and finally returns to the control substrate 110. The control signal transmitted back to the control substrate 110 may be referred to as the response signal (such as the packet including the measured value). Similarly, the control substrate 110 may wirelessly transmit the control signal through the second antenna 114 to the wireless communication device 120-4. The wireless communication device 120-4 receives the control signal through the fourth antenna 125-4 and transmits the control signal to the wireless communication device 120-3 through the third antenna 124-4. The wireless communication devices 120-3-120-1 transmit the control signal in the aforementioned manner in sequence. The control signal passes through wireless communication devices 120-4, 120-3, 120-5, 120-1 in sequence, and finally returns to the control substrate 110. Thus, the wireless communication devices 120-1-120-4 are configured to wirelessly receive the control signal on the first end through the third antennas 124-1-124-4/the fourth antennas 125-1-125-4 from the control substrate 110 or one of the wireless communication devices 120-1-120-4, and then wirelessly transmit the control signal to the control substrate 110 or another one of the wireless communication devices 120-1-120-4 (wireless communication device that is different from the source of the packet) on the second end through the fourth antennas 125-1-125-4/the third antennas 124-1-124-4. The control substrate 110 and the wireless communication devices 120-1-120-4 forms a ring network topology.

In some embodiments, the transmission power of the control substrate 110 and the wireless communication devices 120-1-120-4 is small enough, and the distances between the antennas of the different components are small enough, such that the signal transmitted from the control substrate 110 and the wireless communication devices 120-1-120-4 can only be received by a neighboring component. Specifically, the signal transmitted through the first antenna 113 can only be received by the wireless communication device 120-1 using the third antenna 124-1. Similarly, the signal transmitted through the third antenna 124-1 can only be received by the control substrate 110 using the first antenna 113. The signal transmitted from the control substrate 110 can only be received by the wireless communication devices 120-1, 120-4. Similarly, the signal transmitted through the fourth antenna 125-1 can only be received by the wireless communication device 120-2 using the third antenna 124-2, and the signal transmitted through the third antenna 124-2 can only be received by the wireless communication device 120-1 using the fourth antenna 125-1. Thus, the signal transmitted from the wireless communication device 120-1 can only be received by the control substrate 110 or the wireless communication device 120-2. The signal transmitted from the wireless communication device 120-2 can only be received by the wireless communication device 120-1 or 120-3. The signal transmitted from the wireless communication device 120-3 can only be received by the wireless communication device 120-2 or 120-4. The signal transmitted from the wireless communication device 120-4 can only be received by the wireless communication device 120-3 or the control substrate 110. Thus, two neighboring components may be referred to as communicatively connected to each other or communicatively directly coupled to each other.

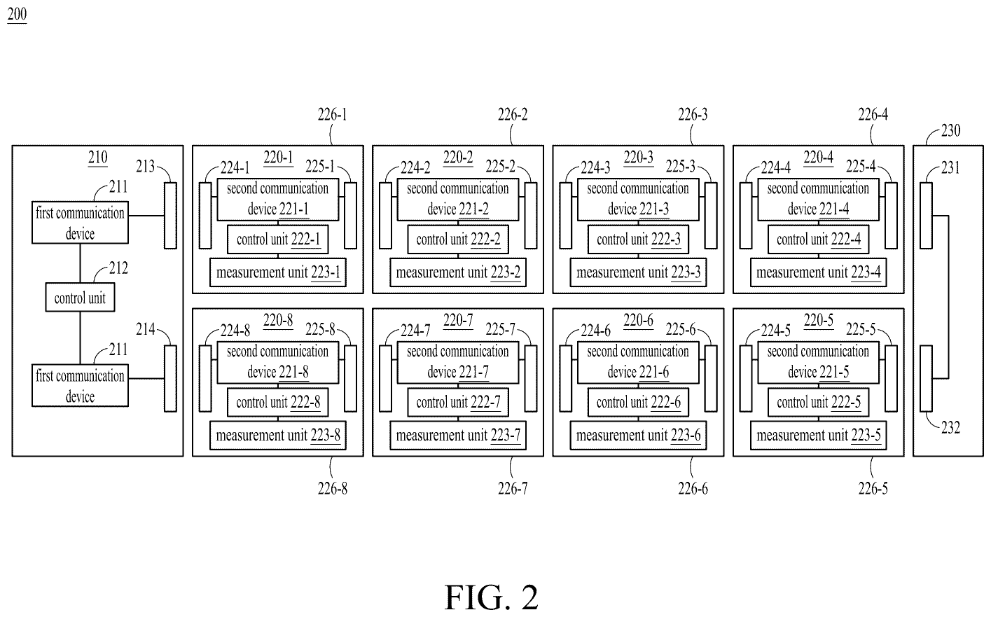

The wireless communication system in accordance to embodiments of the present disclosure may include any number of wireless communication devices. Refer to FIG. 2. FIG. 2 is a block diagram of the wireless communication system 200 in accordance to embodiments of the present disclosure. Wireless communication system 200 comprises the control substrate 210, the wireless communication devices 220-1-220-8, and the signal redirection board 230. The control substrate 210 comprises the first communication device 211 and the control unit 212. The first communication device 211 comprises the first antenna 213 and the second antenna 214. The wireless communication devices 220-1-220-8 respectively comprise the second communication devices 221-1-221-8, the control units 222-1-222-8, and the measurement units 223-1-223-8. The second communication devices 221-1-221-8 comprise the third antennas 224-1-224-8 (also referred to as the fourth antennas 224-1-224-8) and the fourth antennas 225-1-225-8 (also referred to as the third antennas 225-1-225-8). The second communication devices 221-1-221-8, the control units 222-1-222-8, the measurement units 223-1-223-8, the third antennas 224-1-224-8, and the fourth antennas 225-1-225-8 may be mounted on the node substrates 226-1-226-8. The control substrate 210 is similar to the control substrate 110, and the wireless communication devices 220-1-220-8 are similar to the wireless communication devices 120-1-120-4.

The signal redirection board 230 comprises the fifth antenna 231 and the sixth antenna 232. The fifth antenna 231 connects to the sixth antenna 232. The signal redirection board 230 is configured to receive the signal through the fifth antenna 231 and transmit the signal through the sixth antenna 232. Alternatively, the signal redirection board 230 is configured to receive the signal through the sixth antenna 232 and transmit the signal through the fifth antenna 231. Similarly, the signal transmitted through the fifth antenna 231 can only be received by the fourth antenna 225-4, and the signal transmitted through the sixth antenna 232 can only be received by the fourth antenna 225-5.

The wireless communication devices 220-1-220-4 form the first wireless communication group. The wireless communication devices 220-1-220-4 in the first wireless communication group wirelessly communicatively connect to each other in sequence to form the first chain. The wireless communication devices 220-1 and 220-4 at the two ends of the first chain are respectively wirelessly communicatively coupled to the first antenna 213 of the control substrate 210 and the fifth antenna 231 of the signal redirection board 230. The wireless communication devices 220-1-220-8 further includes the second wireless communication group. The wireless communication devices 220-5-220-8 in the second wireless communication group wirelessly communicatively connect to each other in sequence to form the second chain. The wireless communication devices 220-5 and 220-8 at the two ends of the second chain are respectively wirelessly communicatively coupled to the sixth antenna 232 of the signal redirection board 230 and the second antenna 214 of the control substrate 210. The first antenna 213 of the first communication device 211 of the control substrate 210 transmits the control signal to the third antenna 224-1 of the second communication device 221-1 that is directly coupled to the first communication device 211, and the second antenna 214 of the first communication device 211 receives the response signal from the fourth antenna 224-8 of the second communication device 221-8 that is directly coupled to the control substrate 210. Thus, the control signal (such as the packet) transmitted from the control substrate 210 through the first antenna 213 will be transmitted by the wireless communication device 220-1, 220-2, 220-3, 220-4, the signal redirection board 230, the wireless communication device 220-5, 220-6, 220-7, 220-8 in sequence and then be received through the second antenna 214. Alternatively, the control signal (such as the packet) transmitted from the control substrate 210 through the second antenna 215 will be transmitted by the wireless communication device 220-8, 220-7, 220-6, 220-5, the signal redirection board 230, the wireless communication device 220-4, 220-3, 220-2, 220-1 in sequence and then be received through the first antenna 213.

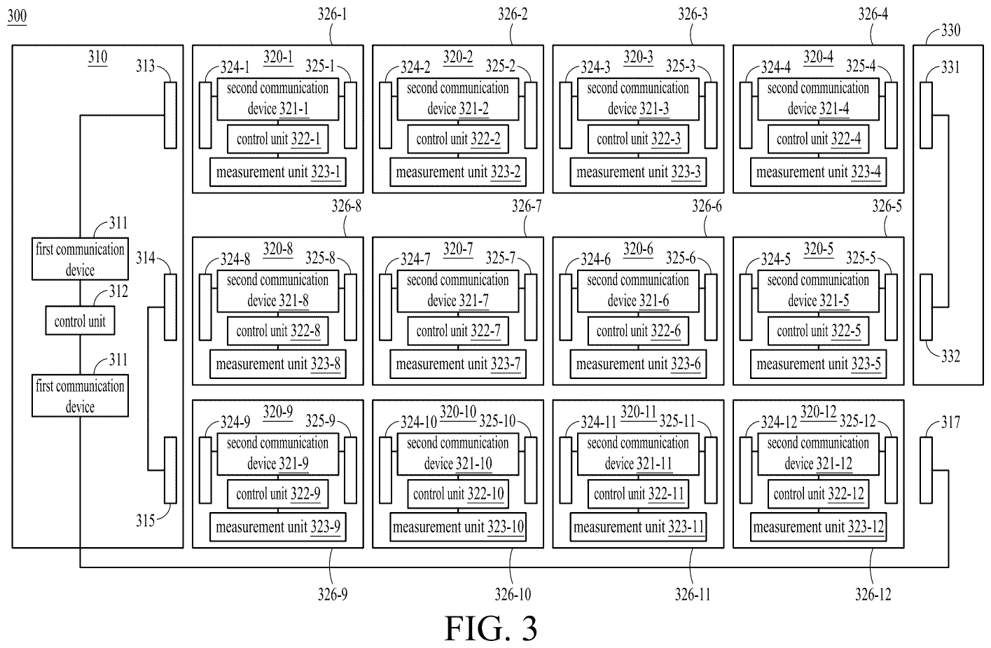

Refer to FIG. 3. FIG. 3 is a block diagram of the wireless communication system 300 in accordance to embodiments of the present disclosure. The wireless communication system 300 comprises the control substrate 310, the wireless communication devices 320-1-320-12, and the signal redirection board 330. The control substrate 310 comprises the first communication device 311 and the control unit 312. The first communication device 311 comprises the first antenna 313 and the second antenna 314. The first communication device 311 of the control substrate 310 further comprises the seventh antenna 315 and the eighth antenna 316. The seventh antenna 315 connects to the second antenna 314. The wireless communication devices 320-1-320-23 respectively comprise the second communication devices 321-1-321-12, the control units 322-1-322-12, and the measurement units 323-1-323-12. The second communication devices 321-1-321-12 comprise the third antennas 324-1-324-12 (also referred to as the fourth antennas 324-1-324-12) and the fourth antennas 325-1-325-12 (also referred to as the third antennas 325-1-325-12). The second communication devices 321-1-321-12, the control units 322-1-322-12, the measurement units 323-1-323-12, the third antennas 324-1-324-12, and the fourth antennas 325-1-325-12 may be mounted on the node substrates 326-1-326-12. The signal redirection board 330 comprises the fifth antenna 331 and the sixth antenna 332. The control substrate 310 is similar to the control substrate 110. The wireless communication devices 320-1-320-12 are similar to the wireless communication devices 120-1-120-4. The signal redirection board 330 is similar to the signal redirection board 230.

The wireless communication devices 320-1-320-4 form the first wireless communication group. The wireless communication devices 320-1-320-4 in the first wireless communication group wirelessly communicatively connect to each other in sequence to form the first chain. The wireless communication devices 320-1 and 320-4 at the two ends of the first chain are respectively wirelessly communicatively coupled to the first antenna 313 of the control substrate 310 and the fifth antenna 331 of the signal redirection board 330. The wireless communication devices 320-1-320-12 further include the second wireless communication group. The wireless communication devices 320-5-320-8 in the second wireless communication group wirelessly communicatively connect to each other in sequence to form the second chain. The wireless communication devices 320-5 and 320-8 at the two ends of the second chain are respectively wirelessly communicatively coupled to the sixth antenna 332 of the signal redirection board 330 and the second antenna 314 of the control substrate 310. The wireless communication devices 320-1-320-12 further include the third wireless communication group. The wireless communication devices 320-9-320-23 in the third wireless communication group wirelessly communicatively connect to each other in sequence to form the third chain. The wireless communication devices 320-9 and 320-12 at the two ends of the third chain are respectively wirelessly communicatively coupled to the seventh antenna 315 and the eighth antenna 316 of the signal redirection board 330. The first antenna 313 of the first communication device 311 of the control substrate 310 transmits the control signal to the third antenna 324-1 of the second communication device 321-1 that is directly coupled to the first communication device 311, and the second antenna 314 of the first communication device 311 receives the response signal from the fourth antenna 324-8 of the second communication device 321-8 that is directly coupled to the control substrate 310. The seventh antenna 315 of the first communication device 311 of the control substrate 310 transmits the control signal to the third antenna 324-9 of the second communication device 321-9 that is directly coupled to the first communication device 311, and the eighth antenna 316 of the first communication device 311 receives the response signal from the fourth antenna 325-12 of the second communication device 321-12 that is directly coupled to the control substrate 310. Thus, the control signal (such as the packet) transmitted from the control substrate 310 through the first antenna 313 will be transmitted by the wireless communication device 320-1, 320-2, 320-3, 320-4, the signal redirection board 330, the wireless communication device 320-5, 320-6, 320-7, 320-8, the second antenna 315, the third antenna 316, the wireless communication device 320-9, 320-10, 320-11, 320-12 in sequence and then be received through the eighth antenna 316 of the control substrate 310. Alternatively, the packet transmitted from the control substrate 310 through the eighth antenna 316 will be transmitted by the wireless communication device 320-12, 320-11, 320-10, 320-9, the third antenna 316, the second antenna 315, the wireless communication device 320-8, 320-7, 320-6, 320-5, the signal redirection board 330, the wireless communication device 320-4, 320-3, 320-2, 320-1 in sequence and then be received through the first antenna 313 of the control substrate 310.

Refer to FIG. 4. FIG. 4 is the schematic diagram of the communication system 200 in accordance to the embodiments of the present disclosure. The wireless communication devices 220-1-220-8 comprises batteries 227-1-227-8. The batteries 227-1-227-8 connect to the node substrates 226-1-226-8. As described above, the second communication devices 221-1-221-8, the control units 222-1-22-8, the measurement units 223-1-223-8, the third antennas 224-1-224-8, and the fourth antennas 225-1-225-8 may be mounted on the node substrates 226-1-226-8. In some embodiments, the batteries 227-1-227-8 is located under the node substrate 226-1-226-8.

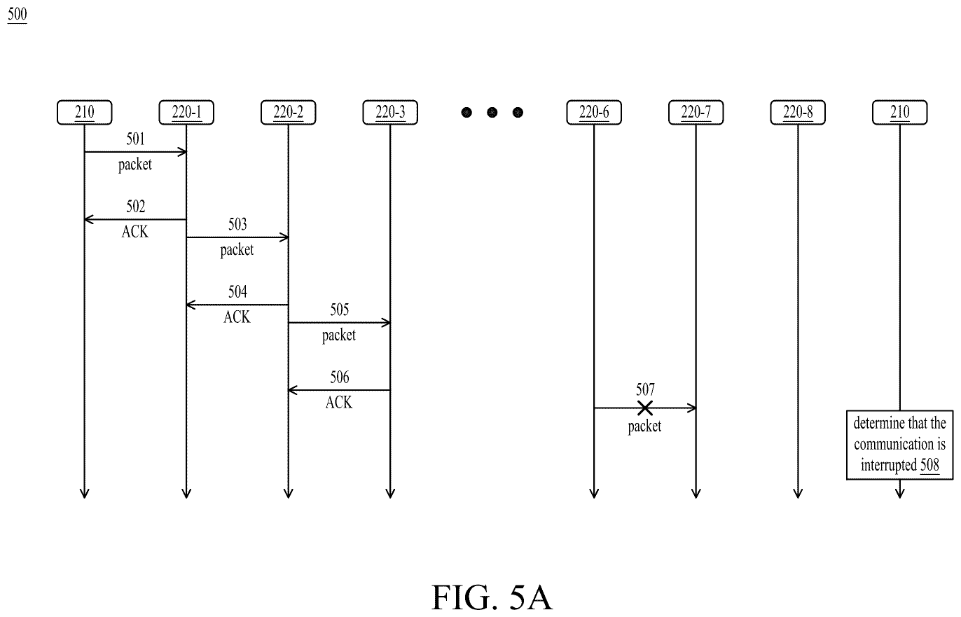

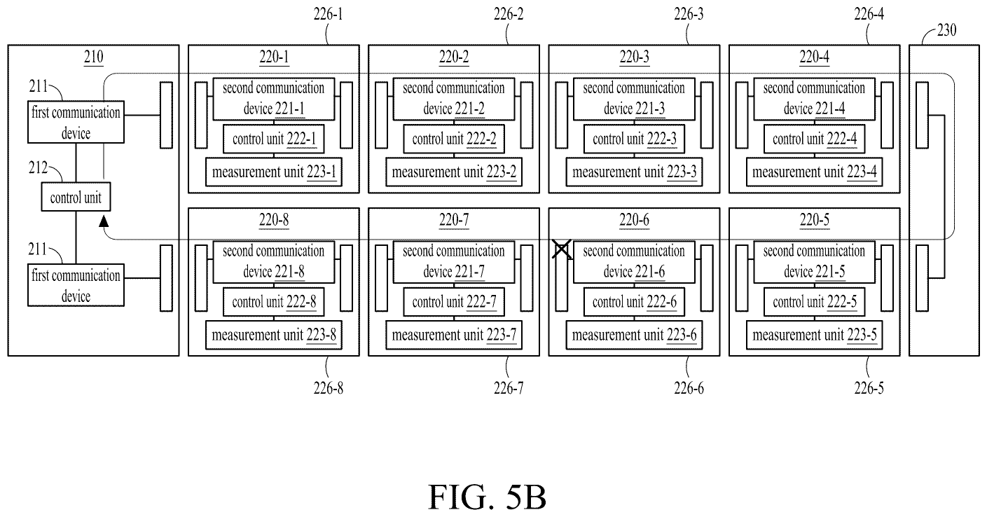

Refer to FIGS. 5A, 5B. FIGS. 5A, 5B are the schematic diagram of the method 500 for controlling the communication system in accordance to the embodiments of the present disclosure. FIGS. 5A, 5B take the wireless communication system 200 shown in the FIG. 2 as an example to illustrate method 500. Method 500 may be used to detect the communication interruption in the wireless communication system. Refer to FIG. 5A. In operation 501, the control substrate 210 transmits the control signal (packet) to the wireless communication device 220-1 through the first antenna 213. The wireless communication device 220-1 receives the packet through the third antenna 224-1. In some embodiments, the packet comprise instruction. The instruction is configured to control one of the wireless communication devices 220-1-220-8 to measure the parameters of the batteries 227-1-227-8 and/or to transmit the measured parameter to the control substrate 210. In operation 502, in response to receiving the packet through the third antenna 224-1, the wireless communication device 220-1 transmits an acknowledge (ACK) message to the control substrate 210 through the third antenna 224-1.

In operation 503, the wireless communication device 220-1 transmits the received packet to the wireless communication device 220-2 through the fourth antenna 225-1. The wireless communication device 220-2 receives the packet through the third antenna 224-2. In operation 504, in response to receiving the packet through the third antenna 224-2, the wireless communication device 220-2 transmits the acknowledgement message to wireless communication device 220-1 through the third antenna 224-2. The wireless communication device 220-1 doesn't forward the acknowledgement message received from the wireless communication device 220-2. Operation 505 is similar to operation 503, and operation 506 is similar to operation 504. After repeatedly applying the above mentioned method to transfer packet, the packet is transmitted to the wireless communication device 220-6.

In operation 507, the wireless communication device 220-6 transmits the received packet to the wireless communication device 220-7 through the third antenna 224-6. However, because the third antenna 224-6 of the wireless communication device 220-6 is broken, the packet cannot be transmitted successfully. In operation 508, in response to not receiving the response signal from the wireless communication devices 220-1-220-8 more than the predetermined amount of time after transmitting the control signal, the control substrate 210 determines that communication among the wireless communication devices 220-1-220-8 is abnormal. In some embodiments, in response to not receiving the packet from the wireless communication device 220-8 more than the predetermined amount of time after transmitting the packet (i.e. the packet transmitted via the control substrate 210 in operation 210), the control substrate 210 determines that communication among the wireless communication devices 220-1-220-8 is abnormal.

Specifically, in the absence of the communication interruption, the control signal (packet) transmitted from the control substrate 210 through the first antenna 213 will be transmitted by the wireless communication devices 220-1, 220-2, 220-3, 220-4, the signal redirection board 230, the wireless communication devices 220-5, 220-6, 220-7, 220-8 in sequence, and then be received by the control substrate 210 through the second antenna 214 (i.e. the received response signal). However, because the third antenna 224-6 is broken, the packet is lost. The control substrate 210 won't receive the transmitted packet through the second antenna 214. Thus, in response to not receiving the packet from the wireless communication device 220-8 more than the predetermined amount of time after transmitting the packet, the control substrate 210 determines that communication among the wireless communication devices 220-1-220-8 is interrupted. In some embodiments, the predetermined amount of time is the time is time required for the packet to be transmitted from the control substrate 210 and back to the control substrate 210 via the wireless communication devices 220-1-220-8.

In some embodiments, in response to the determination that communication among the wireless communication devices is interrupted, the control substrate may inform the operator the failure of the wireless communication system. For example, the control substrate may emit alarm tones, display warning messages, or send messages to other devices so as to inform the operator the failure of the wireless communication system.

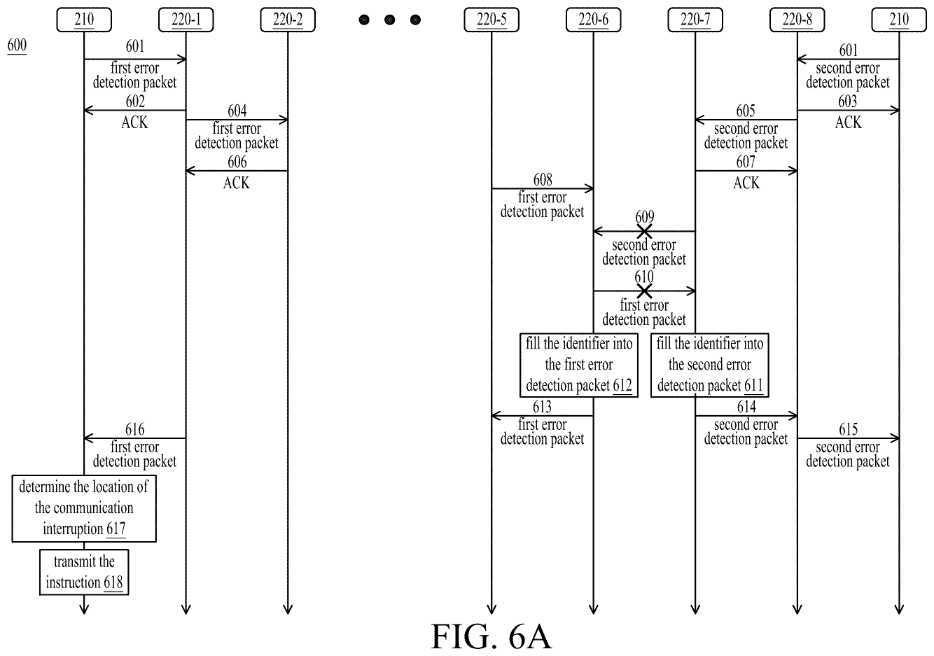

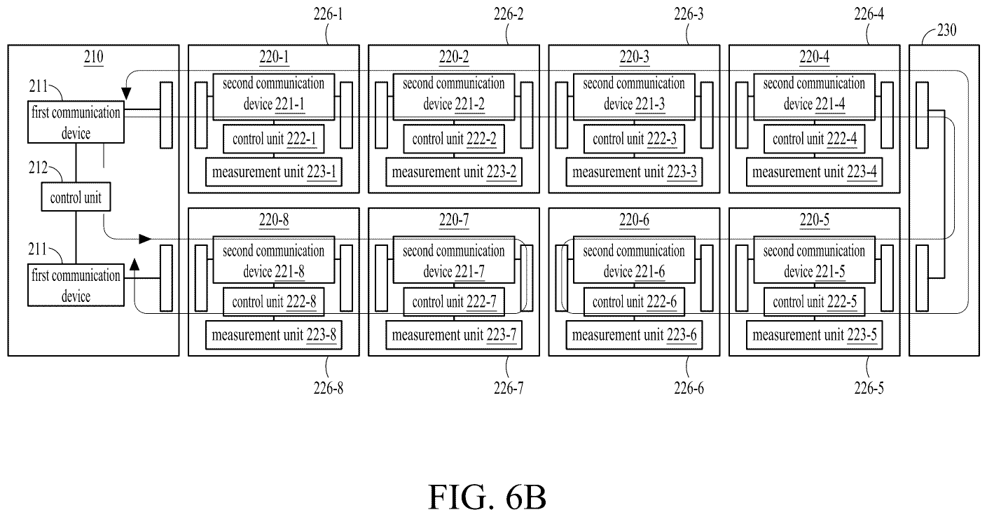

FIGS. 6A, 6B are the schematic diagram of the method 600 for controlling the communication system in accordance to the embodiments of the present disclosure. FIGS. 6A, 6B take the wireless communication system 200 shown in the FIG. 2 as an example to illustrate method 600. Method 600 may be used to detect the location of the interruption and restore the communication in the communication system. Refer to FIG. 6A. In operation 601, in response to the determination that communication among the wireless communication devices 220-1-220-8 is abnormal, the control substrate 210 respectively transmits the first error detection packet to the wireless communication device 220-1 through the first antenna 213 and the second error detection packet to the wireless communication device 220-8 through the second antenna 214. The first error detection packet and the second error detection packet are configured to locate the node substrate 226-1-226-8 with an error among the wireless communication devices 220-1-220-8 (i.e. the wireless communication device with an error). The first error detection packet and the second error detection packet are special packets which are different with the normal packets. In some embodiments, the first error detection packet and the second error detection packet comprise reserved fields. The reserved field allows the wireless communication devices 220-1-220-8 to fill in their own identifier.

In operation 602, in response to receiving the first error detection packet through the third antenna 224-1, the wireless communication device 220-1 transmits the acknowledgement message to the control substrate 210 through the third antenna 224-1. In operation 603, in response to receiving the second error detection packet through the third antenna 224-8, the wireless communication device 220-8 transmits the acknowledgement message to the control substrate 210 through the third antenna 224-8. In operation 604, the wireless communication device 220-1 transmits the first error detection packet to the wireless communication device 220-2 through the fourth antenna 225-1. The wireless communication device 220-2 receives the first error detection packet through the third antenna 224-2. In operation 605, the wireless communication device 220-8 transmits the second error detection packet to the wireless communication device 220-7 through the fourth antenna 225-8. The wireless communication device 220-7 receives the second error detection packet through the third antenna 224-7. In operation 606, in response to receiving the first error detection packet through the third antenna 224-2, the wireless communication device 220-2 transmits the acknowledgement message to the wireless communication device 220-1 through the third antenna 224-2. In operation 607, in response to receiving the second error detection packet through the third antenna 224-7, the wireless communication device 220-7 transmits the acknowledgement message to the wireless communication device 220-8 through the third antenna 224-7.

The first error detection packet and the second error detection packet are transmitted applying the above mentioned method repeatedly. The first error detection packet is transmitted among the wireless communication devices 220-1-220-8 along the first direction, and the second error detection packet is transmitted among the wireless communication devices 220-1-220-8 along the second direction. The first direction is from the control substrate 210 to the wireless communication devices 220-1, 220-2, 220-3, 220-4, the signal redirection board 230, the wireless communication devices 220-5, 220-6, 220-7, 220-8 in sequence. The second direction is from the control substrate 210 to the wireless communication devices 220-8, 220-7, 220-6 220-5, the signal redirection board 230, the wireless communication devices 220-4, 220-3, 220-2, 220-1 in sequence.

In operation 608, in response to receiving the first error detection packet through the fourth antenna 225-5, the wireless communication device 220-5 transmits the first error detection packet to the wireless communication device 220-6 through the third antenna 224-5. The wireless communication device 220-6 receives the first error detection packet through the fourth antenna 225-6. In operation 609, in response to receiving the second error detection packet through the third antenna 224-7, the wireless communication device 220-7 transmits the second error detection packet to the wireless communication device 220-6 through the fourth antenna 224-7. However, because the third antenna 224-6 of the wireless communication device 220-6 is broken, the second error detection packet cannot be transmitted successfully. In operation 610, the wireless communication device 220-6 transmits the first error detection packet to the wireless communication device 220-7 through the third antenna 224-6. However, because the third antenna 224-6 of the wireless communication device 220-6 is broken, the first error detection packet cannot be transmitted successfully. In operation 611, in response to not receiving the acknowledgement message (from the wireless communication device 220-8) through the fourth antenna 225-7 more than the predetermined amount of time after transmitting the second error detection packet, the wireless communication device 220-7 determines that the transmission of the second error detection packet has failed. In response to the determination that the transmission of the second error detection packet has failed, the wireless communication device 220-7 fills its own identifier into the second error detection packet. In operation 612, in response to not receiving the acknowledgement message (from the wireless communication device 220-7) through the third antenna 224-6 more than the predetermined amount of time after transmitting the first error detection packet, the wireless communication device 220-6 determines that the transmission of the first error detection packet has failed. In response to the determination that the transmission of the first error detection packet has failed, the wireless communication device 220-6 fills its own identifier into the first error detection packet. Thus, after wirelessly transmitting the first/second error detection packet through the fourth/third antenna, the wireless communication devices 220-1-220-8 determines that the transmission of the first error detection packet or the second error detection packet has failed, in response to not receiving the acknowledgement message through the fourth/third antenna more than the predetermined amount of time.

In operation 613, the wireless communication device 220-6 transmits the first error detection packet to the wireless communication device 220-5 through the fourth antenna 225-6. In operation 614, the wireless communication device 220-7 transmits the second error detection packet to the wireless communication device 220-8 through the third antenna 224-7.

Thus, after receiving the error detection packet (such as the first error detection packet or the second error detection packet) through the third/fourth antenna on one end, the wireless communication devices 220-1-220-8 will transmit the error detection packet through the fourth/third antenna on the other end. In response to the determination that the transmission of the error detection packet has failed, the wireless communication devices 220-1-220-8 transmit the error detection packet through the third/fourth antenna on the same end. In other words, after receiving the error detection packet from one of the wireless communication devices 220-1-220-8 or the control substrate 210, the wireless communication devices 220-1-220-8 transmit the error detection packet to the other one of the wireless communication devices 220-1-220-8 (instead of the source of the error detection packet) or the control substrate 210. In response to the determination that the transmission of the error detection packet has failed, the wireless communication devices 220-1-220-8 transmit the error detection packet to the one of the wireless communication devices 220-1-220-8 (the source of the error detection packet).

After operations 613, 614, as shown in FIG. 6A, the wireless communication devices 220-1-220-8 transmit the first error detection packet and the second error detection packet in sequence. Finally, the first error detection packet and the second error detection packet are transmitted back to the control substrate 210. Specifically, after operation 613, 614, the wireless communication devices 220-1-220-8 transmit the first error detection packet and the second error detection packet in a “after receiving the error detection packet on one end through the third/fourth antenna, transmitting the error detection packet on the other end through the fourth/third antenna”, such that the first error detection packet and the second error detection packet are transmitted back to the control substrate 210.

Refer to FIG. 6B. The first error detection packet is transmitted by the control substrate 210, the wireless communication device 220-1, 220-2, 220-3, 220-4, the signal redirection board 230, the wireless communication device 220-5, 220-6, the signal redirection board 230, the wireless communication device 220-4, 220-3, 220-2, 220-1 in sequence and then back to the control substrate 210. The second error detection packet is transmitted by the control substrate 210, the wireless communication device 220-8, 220-7, 220-8 in sequence and then back to the control substrate 210.

In operation 615, the control substrate 210 wirelessly receives the second error detection packet which records the identifier of the wireless communication device 220-7 from the wireless communication device 220-8 through the second antenna 214. In operation 616, the control substrate 210 wirelessly receives the first error detection packet which records the identifier of the wireless communication device 220-6 from the wireless communication device 220-1 through the first antenna 213. In operation 617, the control substrate determines the location of the communication interruption. The control substrate 210 determines that the communication between the wireless communication device 220-6 and the wireless communication device 220-7 is interrupted. The control substrate 210 determines that the node substrate 226-6, 226-7 have error.

In operation 618, the control substrate 210 transmits instructions to the node substrates with an error. The control substrate 210 transmits instructions to the wireless communication devices 220-6, 220-7. In some embodiments, the control substrate 210 respectively transmits instructions through the first antenna 213 and the second antenna 214. The instructions are respectively transmitted to the wireless communication devices 220-6, 220-7 along the first direction and the second direction. The wireless communication devices 220-6, 220-7 change the behavior (or operation mode) after receiving the instructions. After receiving the instructions, in response to receiving the control signal through the third antenna 224-6, 224-7 (or the fourth antenna 225-6, 225-7), the wireless communication devices 220-6, 220-7 transmit the response signal through the third antenna 224-6, 224-7 (or the fourth antenna 225-6, 225-7). Specifically, after receiving the instructions, in response to receiving the control signal (e.g. packet) through the third/fourth antenna on one end, the wireless communication devices 220-6, 220-7 transmit the response signal (e.g. packet) through the third/fourth antenna on the same end. In other words, after receiving the packet from one of the wireless communication devices 220-1-220-8 on one end, the wireless communication devices 220-6, 220-7 transmit the packet to the one of the wireless communication devices 220-1-220-8 (i.e. the source of the packet). Thus, after operation 618, the control substrate 210 ant the wireless communication devices 220-1-220-8 switch from the ring network topology to the daisy chain network topology.

Refer to FIG. 6B. After operation 618, the packet is transmitted by the control substrate 210, the wireless communication device 220-1, 220-2, 220-3, 220-4, the signal redirection board 230, the wireless communication device 220-5, 220-6, 220-5, the signal redirection board 230, the wireless communication device 220-4, 220-3, 220-2, 220-1 in sequence, and then back to the control substrate 210. Alternatively, the packet is transmitted by the control substrate 210, the wireless communication device 220-8, 220-7, 220-8 in sequence, and then back to the control substrate 210.

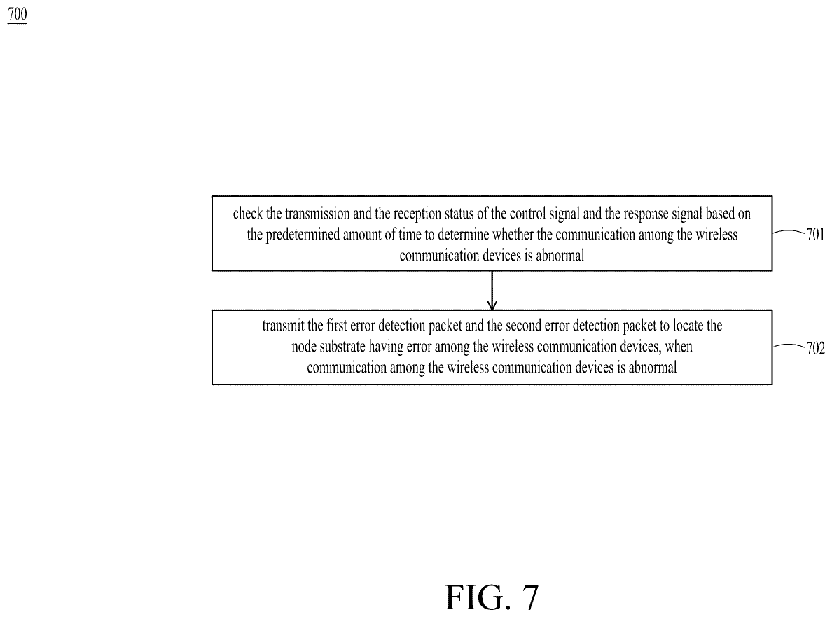

Refer to FIG. 7. FIG. 7 is the flow diagram of the method 700 for controlling the communication system in accordance to the embodiments of the present disclosure. Method 700 may be applied in the wireless communication systems 100-300. The following illustrates the method 700 referring to the examples shown in FIGS. 2, 5A, 5B, 6A, 6B. In operation 701, the control substrate 210 checks the transmission and the reception status of the control signal and the response signal based on the predetermined amount of time to determine whether communication among the wireless communication devices 220-1-220-8 is abnormal. In some embodiments, the control unit 212 of the control substrate 210 determines that communication among the wireless communication devices 220-1-220-8 is abnormal, in response to not receiving the response signal from the wireless communication devices 220-1-220-8 more than the predetermined amount of time after transmitting the control signal. In operation 702, the first communication device 211 is configured to transmit the first error detection packet and the second error detection packet to locate the node substrate having an error among the wireless communication devices 220-1-220-8, when communication among the wireless communication devices 220-1-220-8 is abnormal.

Embodiments of the present disclosure provide wireless communication systems and methods for controlling the wireless communication system. The wireless communication system and the method in accordance to the embodiments of the present disclosure are able to determine the location of the communication interruption. Furthermore, the wireless communication system and the method in accordance to the embodiments of the present disclosure are able to restore the communication, after determining the location of the communication interruption

The embodiments are illustrated or described using a series of operations or events. However, it should be understood that the order of the description of the operations or events should not be used to limit the present disclosure. For example, some operations may happens in different order, some described operation or events may be removed, and different operations may happens at the same time within reasonable limits. Furthermore, the described one or more operations may be performed in one or more separate operations and/or stages.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless communication system, comprising:
a control substrate having a first communication device, wherein the first communication device is equipped with a first antenna and a second antenna;
a plurality of wireless communication devices including a first wireless communication group, wherein each of the wireless communication devices comprises:
a node substrate comprising a second communication device, wherein the second communication device has a third antenna located on a first end of the node substrate and a fourth antenna located on a second end, which is relative to the first end, of the node substrate;
wherein the wireless communication devices in the first wireless communication group wirelessly communicatively connect to each other in sequence to form a first chain, wherein the wireless communication devices at the two ends of the first chain are respectively wirelessly communicatively coupled to the first antenna and the second antenna of the first communication device of the control substrate;
wherein the first antenna of the first communication device of the control substrate transmits a control signal to the third antenna of the second communication device that is directly coupled to the first communication device, and the second antenna of the first communication device receives a response signal from the fourth antenna of the second communication device that is directly coupled to the first communication device;
wherein the control substrate is configured to check the transmission and the reception status of the control signal and the response signal based on a predetermined amount of time to determine whether communication among the wireless communication devices is abnormal;
wherein the first communication device is configured to transmit a first error detection packet and a second error detection packet to locate the node substrate having an error among the wireless communication devices, when communication among the wireless communication devices is abnormal.

2. The wireless communication system as claimed in claim 1, further comprising:
a signal redirection board, comprising a fifth antenna and a sixth antenna;
wherein the wireless communication devices at the two ends of the first chain are respectively wirelessly communicatively coupled to the first antenna of the control substrate and the fifth antenna of the signal redirection board;
wherein the wireless communication devices further include a second wireless communication group, and the wireless communication devices in the second wireless communication group wirelessly communicatively connect to each other in sequence to form a second chain, wherein the wireless communication devices at the two ends of the second chain are respectively wirelessly communicatively coupled to the sixth antenna of the signal redirection board and the second antenna of the control substrate.

3. The wireless communication system as claimed in claim 2, wherein the control substrate further comprises a seventh antenna and an eighth antenna, wherein the seventh antenna connects to the second antenna;
wherein the wireless communication devices further include a third wireless communication group, and the wireless communication devices in the third wireless communication group wirelessly communicatively connect to each other in sequence to form a third chain, wherein the wireless communication devices at the two ends of the third chain are respectively wirelessly communicatively coupled to the seventh antenna and the eighth antenna of the control substrate.

4. The wireless communication system as claimed in claim 1, wherein after the first error detection packet or the second error detection packet are wirelessly transmitted through the fourth antenna, the wireless communication devices are configured to:
determine that the transmission of the first error detection packet or the second error detection packet has failed, in response to not receiving an acknowledgement message through the fourth antenna more than the predetermined amount of time.

5. The wireless communication system as claimed in claim 1, wherein the control substrate is further configured to:
transmit an instruction to the node substrate with the error to cause the node substrate with the error to:
transmit the response signal through the third antenna, in response to receiving the control signal through the third antenna.

6. The wireless communication system as claimed in claim 1, wherein the control unit is configured to:
determine that communication among the wireless communication devices is abnormal, in response to not receiving the response signal from the wireless communication devices more than the predetermined amount of time after transmitting the control signal.

7. The wireless communication system as claimed in claim 1, wherein each of the wireless communication devices further comprises:
a battery connected to the node substrate; and
a measurement unit, configured to measure parameters of the battery.

8. A method for controlling wireless communication system, applicable to a wireless communication system, wherein the wireless communication system comprises a control substrate and a plurality of wireless communication devices, the control substrate comprises a first communication device, and the first communication device is equipped with a first antenna and a second antenna; wireless communication devices include a first wireless communication group, each of the wireless communication devices comprises a node substrate and a second communication device, a third antenna is located on a first end of the node substrate, and a fourth antenna is located on a second end, which is relative to the first end, of the node substrate; wherein the wireless communication devices in the first wireless communication group wirelessly communicatively connect to each other in sequence to form a first chain, wherein the wireless communication devices at the two ends of the first chain are respectively wirelessly communicatively coupled to the first antenna and the second antenna of the first communication device of the control substrate; wherein the first antenna of the first communication device of the control substrate transmits a control signal to the third antenna of the second communication device that is directly coupled to the first communication device, and the second antenna of the first communication device receives a response signal from the fourth antenna of the second communication device that is directly coupled to the first communication device;
wherein the method comprises:
checking the transmission and the reception status of the control signal and the response signal based on a predetermined amount of time to determine whether communication among the wireless communication devices is abnormal using the control substrate; and
transmitting a first error detection packet and a second error detection packet to locate the node substrate having an error among the wireless communication devices using the first communication device, when communication among the wireless communication devices is abnormal.

9. The method as claimed in claim 8, further comprising:
transmitting an instruction to the node substrate with the error using the control substrate to cause the node substrate with the error to:
transmit the response signal through the third antenna, in response to receiving the control signal through the third antenna.

10. The method as claimed in claim 8, further comprising:
determining that communication among the wireless communication devices is abnormal using the control unit, in response to not receiving the response signal from the wireless communication devices more than the predetermined amount of time after transmitting the control signal.
